(19) United States
(12) Patent Application Publication
(10) Pub. No.: US 2025/0010454 A1
(43) Pub. Date: Jan. 9, 2025

(54) Driving Tool with Engagement Bit Storage

(71) Applicant: Milwaukee Electric Tool Corporation, Brookfield, WI (US)

(72) Inventors: Matthew A. Lownik, Wauwatosa, WI (US); Christopher M. Wesloski, Waukesha, WI (US); Maria Krutikova, Wauwatosa, WI (US); Lucas M. Schmidt, Eagle, WI (US)

(21) Appl. No.: 18/674,283

(22) Filed: May 24, 2024

Related U.S. Application Data
(60) Provisional application No. 63/520,204, filed on Aug. 17, 2023.
(60) Provisional application No. 63/526,402, filed on Jul. 12, 2023.
(60) Provisional application No. 63/512,481, filed on Jul. 7, 2023.

(51) Int. Cl. B25G 1/08; B25B 23/00

(52) U.S. Cl. CPC B25G 1/085; B25B 23/0035

(57) ABSTRACT

Various embodiments of a driving tool that includes storage for retaining engagement bits in the handle of the driving tool are provided. In a certain embodiment, the driving tool includes a handle, a shaft, and an engagement bit. The handle has a first end and a second end opposite the first end along a longitudinal axis. A cavity is formed in the handle and configured to removably secure the engagement bit within the cavity. The cavity is centered on and extends along a cavity axis. The cavity axis is oriented at an angle with respect to the longitudinal axis such that the cavity axis intersects the longitudinal axis.

### CROSS-REFERENCE TO RELATED PATENT APPLICATIONS

The present application claims the benefit of and priority to U.S. Provisional Application 63/520,204, filed on Aug. 17, 2023, U.S. Provisional Application No. 63/526,402, filed on Jul. 12, 2023, and U.S. Provisional Application No. 63/512,481, filed Jul. 7, 2023, each of which are incorporated herein by reference in their entireties.

### BACKGROUND OF THE INVENTION

The present disclosure is directed generally to the field of tools. The present disclosure relates specifically to a driving tool, such as a nut driver, screwdriver, etc., that includes storage in the handle of the driving tool for engagement bits, such as driving sockets, screwdriver bits, etc.

### SUMMARY OF THE INVENTION

One embodiment of the invention relates to a driving tool. The driving tool extends along a longitudinal axis. The driving tool includes a handle, a shaft, and an engagement bit. The handle has a first end and a second end opposite the first end along the longitudinal axis. The shaft is coupled to the first end of the handle. A cavity is formed in the handle at a position located between the first end and the second end. The cavity is centered on and extends along a cavity axis. The cavity axis is oriented at an angle with respect to the longitudinal axis such that the cavity axis intersects the longitudinal axis. The engagement bit is removably secured within the cavity.

Another embodiment of the invention relates to a driving tool with a handle, a shaft, a first bit, and a second bit. The handle extends along a longitudinal axis. The handle has a first end and a second end opposite the first end along the longitudinal axis. The shaft is coupled to the first end of the handle. The first bit and the second bit are both configured to engage a mounting end of the shaft. The driving tool includes a first cavity configured to receive and retain the first bit and a second cavity configured to receive and retain the second bit. A solid area is formed within the handle extending without openings in a direction along the longitudinal axis between the first cavity and the second cavity.

Another embodiment of the invention relates to a driving tool including a socket and a shaft. The socket is centered on and extends along a longitudinal axis. The socket includes a first end, a second end opposite the first end along the longitudinal axis, and an outer side wall extending along the socket between the first end and the second end. A first channel is formed in the socket extending along the longitudinal axis from the first end to the second end. A second channel is formed in the socket at a position located between the first end and the second end such that the second channel intersects the first channel. The second channel defines an opening along the outer side wall. The shaft includes a mounting end configured to be received and retained within the second channel. When the shaft is received in the second channel, the shaft can be rotated around the longitudinal axis to drive a fastener into a workpiece.

Additional features and advantages will be set forth in the detailed description which follows, and, in part, will be readily apparent to those skilled in the art from the description or recognized by practicing the embodiments as described in the written description included, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a side plan view of a driving tool, according to an exemplary embodiment;

FIG. 2 is a side perspective view of the driving tool of FIG. 1, according to an exemplary embodiment;

FIG. 3 is a detailed view of the shaft of the driving tool of FIG. 1, according to an exemplary embodiment;

FIG. 4 is a side plan view of the driving tool of FIG. 1 with a side mounted shaft, according to an exemplary embodiment;

FIG. 5 is a side plan view of the driving tool of FIG. 1 with the engagement bits removed from the storage cavities, according to an exemplary embodiment;

FIG. 6 is a side plan view of the handle of FIG. 1 with the engagement bits removed from the storage cavities, according to an exemplary embodiment;

FIG. 7 is a side plan view of the driving tool of FIG. 1 with the engagement bits engaged in the storage cavities, according to an exemplary embodiment;

FIG. 8 is a detailed view of the engagement bits of the driving tool of FIG. 1, according to an exemplary embodiment;

FIG. 9 is a side plan view of the driving tool of FIG. 1 with the shaft engaged in the shaft receiver, according to an exemplary embodiment;

FIG. 10 is a front perspective view of an engagement bit with a radial channel, according to another exemplary embodiment;

FIG. 11 is a side plan view of the engagement bit of FIG. 10, according to an exemplary embodiment;

FIG. 12 is a perspective view of a shaft engaged in the radial channel of the engagement bit of FIG. 10, according to an exemplary embodiment; and

FIG. 13 is a side plan view of an engagement bit with a through bore, according to another exemplary embodiment.

### DETAILED DESCRIPTION

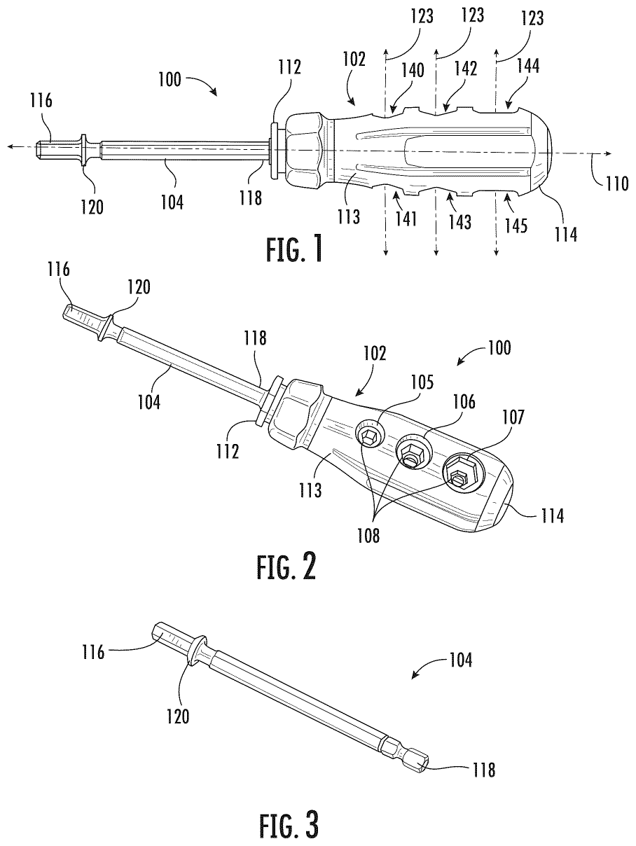

Referring generally to FIGS. 1-8, various embodiments of a driving tool with handle storage for multiple engagement bits are shown. Applicant believes that the driving tools discussed herein provide for various advantages over typical driving tools with handle storage, such as designs in which bits are stored axially through the end of the handle or enclosed within the body of the handle.

Specifically, the driving tools discussed herein have multiple individual cavities formed in the handle. In certain embodiments, these cavities are oriented such that the axis of each cavity is perpendicular to the longitudinal axis of the handle. It is believed that perpendicular storage provides easier access to the bits because it allows a user access to a specific bit without the need to remove the shaft, a portion of the handle, and/or take out the other bits to get to the specific one. Further, compared to axial storage arrangements, the individual bit cavity designs discussed herein are specifically sized for each stored bit and, thus, does not allow the bits to slide or bounce around the shaft or within the handle.

In additional embodiments, various embodiments of an engagement bit configured to receive a shaft are provided. Specifically, the engagement bit is a socket that includes a radial channel or through bore located between the ends of the socket. It is believed that this centrally located channel, or through bore, provides a user with a convenient method for allowing a shaft of a driving tool to act as a T-bar for driving fasteners. This has been found to provide greater leverage when driving a fastener.

Referring generally to FIGS. 1-9, a driving tool 100, such as a nut driver, screwdriver, etc., is shown and described. Driving tool 100 includes a handle 102 and a shaft 104. Driving tool 100 further includes a plurality of storage cavities (e.g., through holes), shown as first cavity 105, second cavity 106, and third cavity 107, along handle 102 for storage of multiple engagement bits shown as nut driving sockets 108. In other embodiments, handle 102 is configured to store other types of engagement bits, such as screwdriver bits, drill bits, etc. In the specific embodiment shown, driving tool 100 is a nut driver and sockets 108 are reversible sockets, including different sized socket engagement surfaces at opposing ends of the socket.

Referring to FIGS. 1 and 2, driving tool 100 extends along and is centered on longitudinal axis 110. Handle 102 has a first end 112 and a second end 114. Second end 114 is located opposite first end 112 along longitudinal axis 110. Shaft 104 is configured to be removably coupled to first end 112. When coupled to first end 112 of handle 102, shaft 104 extends away from first end 112 and second end 114 in a direction along longitudinal axis 110. Shaft 104 has a first end or mounting end 116 that is configured to receive sockets 108. A second end 118 of shaft 104 is located opposite from mounting end 116. Second end 118 is configured to couple to handle 102. In the embodiment shown, second end 118 is removably coupled to first end 112 of handle 102. In other embodiments, second end 118 of shaft 104 may be fixedly coupled to handle 102, or shaft 104 may formed as a single unitary body with handle 102.

Referring to FIG. 3, shaft 104 is shown in more detail. Mounting end 116 of shaft 104 is shaped to receive and retain sockets 108. As shown, shaft 104 includes a flange 120 located proximate to mounting end 116. Flange 120 is configured to stop sockets 108 from sliding or moving along shaft 104. Flange 120 is spaced from mounting end 116 to allow for sockets 108 to be inserted onto and slide into secured engagement on mounting end 116. Flange 120 is formed from a single, contiguous, and continuous material with shaft 104 and extends radially outward from shaft 104. As shown, mounting end 116 is a hexagonal shape, but mounting end 116 may be any shape for engaging sockets 108, such as square, rectangle, etc. Additionally, mounting end 116 may include a protrusion or elongated tip for inserting into sockets 108 or may include an opening or recess for receiving sockets 108 within mounting end 116.

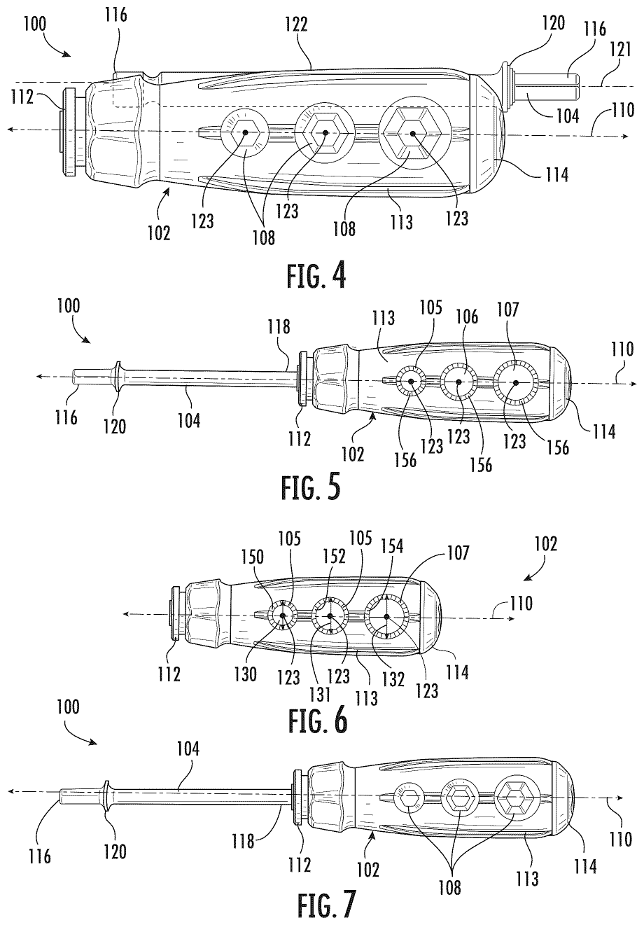

Referring to FIG. 4, in various embodiments, handle 102 includes a shaft storage cavity or channel 122. Channel 122 is formed in handle 102 and extends along at least a portion of handle 102. Channel 122 is centered on and extends along a channel axis 121. Channel axis 121 is spaced a distance from longitudinal axis 110. In a specific embodiment, channel axis 121 is oriented skew to longitudinal axes or cavity axes 123 of cavities 105, 106, and 107 such that channel axis 121 does not intersect with cavity axes 123 and channel axis 121 is not parallel to cavity axes 123.

Channel 122 is configured to receive and retain shaft 104 to store shaft 104 along handle 102. As shown, shaft 104 has been uncoupled from first end 112 and is mounted in channel 122. In a specific embodiment, channel 122 is oriented in a direction parallel to longitudinal axis 110. In such embodiment, shaft 104 is stored parallel to handle 102 and offset from longitudinal axis 110 along a side of handle 102.

Referring to FIGS. 5-7, cavities 105, 106, and 107 are shown formed in handle 102. Specifically, cavities 105-107 are formed in handle 102 at a position located between first end 112 and second end 114. Each cavity 105, 106 and 107 is separate and distinct from each other, which means that there is a solid area formed within handle 102 extending without openings in a direction along the longitudinal axis 110 between each cavity 105-107.

Cavities 105-107 extend through the width of handle 102. Cavities 105-107 include two open ends, which can allow access to sockets 108 from either side of handle 102 when sockets 108 are retained within cavities 105-107. Cavity 105 includes a first open end, or first opening 140, and a second open end, or second opening 141, opposite first opening 140 along cavity axis 123. Cavity 106 includes a first open end, or first opening 142, and a second open end, or second opening 143, opposite first opening 142 along cavity axis 123. Cavity 107 includes a first open end, or first opening 144, and a second open end, or second opening 145, opposite first opening 144 along cavity axis 123. Openings 140-145 are defined along an outer side surface 113 of handle 102. Outer side surface 113 extends between first end 112 and second end 114. In this way, cavities 105-107 are configured such that sockets 108 can be removed from cavities 105-107 through first openings 140, 142, 144. In certain embodiment, cavities 105-107 are configured such that sockets 108 can be removed from second openings 141, 143, 145.

Each cavity 105, 106, and 107 extends along and is centered on a cavity axis 123. Cavity axes 123 are oriented at an angle 125 with respect to longitudinal axis 110 such that cavity axes 123 intersect longitudinal axis 110. In a specific embodiment, angle 125 is between 45 degrees and 135 degrees, and more specifically, between 80 degrees and 110 degrees. In certain embodiments, cavity axes 123 are oriented in a direction perpendicular to longitudinal axis 110 of handle 102, such that cavity axes 123 each intersect longitudinal axis 110 at a right angle, or within a few degrees of a right angle.

As shown in FIG. 6, cavity 105 has an opening area that is less than the opening area of cavity 106 and 107. Cavity 106 has an opening area less than cavity 107 and greater than the opening area of 105. Cavity 107 has an opening area greater than cavities 105 and 106. More specifically, cavity 105 has a width 130 that is less than a width 131 of cavity 106. Width 131 is greater than width 130 of cavity 105, but width 131 is less than a width 132 of cavity 107. Width 132 of cavity 107 is greater than width 130 of cavity 105 and width 131 of cavity 106. Additionally, cavity 105 is located closest to first end 112 of handle 102 and cavity 107 is located closest to second end 114 of handle 102. Cavity 106 is located between cavities 105 and 107 and is evenly spaced between cavities 105 and 107. In this way, cavities 105-107 are arranged along handle 102 in order of size from smallest opening area to largest opening area.

Each cavity 105, 106, and 107 is sized to receive and retain a corresponding socket 108. In specific embodiments, sockets 108 are secured within their corresponding cavities through an interference fit. Specifically, cavity 105 is sized to create a light press-fit between an interior wall 150 of the cavity 105 and an outer wall 151 of a corresponding socket 108. Cavity 106 is sized to create a light press-fit between an interior wall 152 of the cavity 105 and an outer wall 153 of a corresponding socket 108. Cavity 106 is sized to create a light press-fit between an interior wall 154 of the cavity 105 and an outer wall 155 of a corresponding socket 108. As shown, interior wall 150, 152, 154 are inside walls of handle 102.

In other embodiments, snaps, ball detents, or over-molding are used to help secure the sockets 108 in place within cavities 105-107. In other embodiments, a quarter-turn locking mechanism may be used to hold sockets 108 in place within handle 102. In other embodiments, cavities 105-107 include a metal insert with one or more retention mechanisms to support sockets 108 within handle 102, such as magnets, collars, lock nuts, etc. In some embodiments, plurality of cavities 105-107 each include a step 156. With reference to cavity 105, step 156 is positioned adjacent to second opening 141 of cavity 105 and extends from interior wall 150 in a direction towards cavity axis 123, so that socket 108 can only enter cavity 105 from one direction. Step 156 is similarly positioned along cavities 106 and 107.

In the specific embodiment shown, handle 102 includes three cavities 105, 106, and 107 for holding three different sized sockets 108. However, more cavities may be included along handle 102 to hold more sockets 108. Additionally, in certain embodiments, cavities are included on shaft 104. In such an embodiment, driving tool 100 could store even more sockets 108. For example, five or six reversible sockets 108 could be stored along driving tool 100.

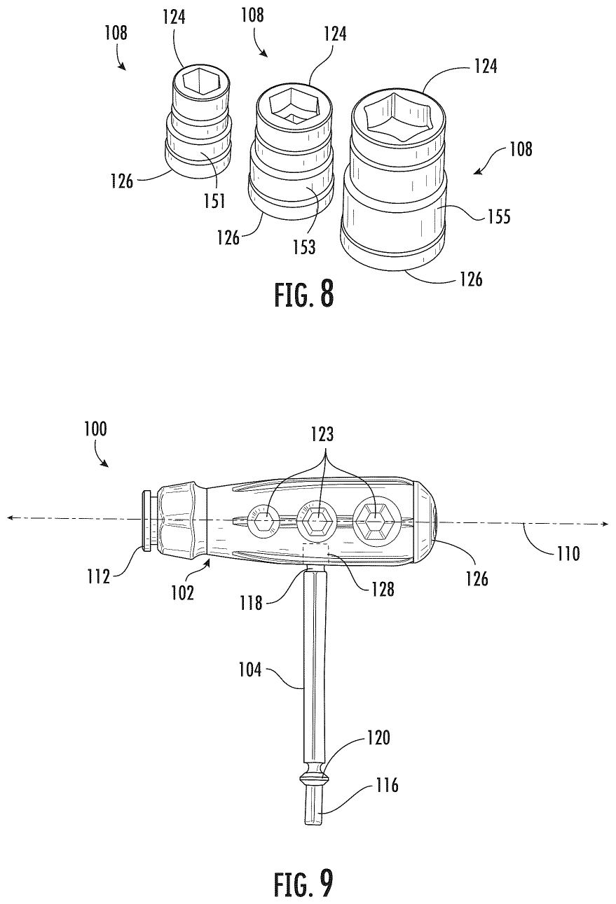

Sockets 108 are removably secured within in cavities 105-107 such that they may be stored within handle 102. Sockets 108 include socket bits, screw driver bits, and the like. Sockets 108 are configured to engage mounting end 116 of shaft 104. As shown in FIG. 8, each socket 108 is differently sized and shaped from each other to engage a variety of fasteners (nuts, screws, etc.). Each socket 108 includes include a first end 124 and a second end 126. Second end 126 is located opposite first end 124 and has a larger circumference than first end 124. In this way, first end 124 is configured to receive a differently sized fastener than second end 126. As shown, sockets 108 are a ¼ inch and 5/16 inch reversible socket, a ⅜ inch and 7/16 inch reversable socket, and a ½ inch and 9/16 inch reversable socket.

As shown, sockets 108 are generally cylinder shaped with hexagonal openings for receiving fasteners or shaft 104. However, sockets 108 may be a variety of shapes (circular, hexagonal, square, rectangular, etc.) and sizes (¼ inch, ⅜ inch, etc.). Mounting end 116 of shaft 104 may be shaped the same shape as sockets 108 to allow for engaging and retaining of sockets 108. As shown, both mounting end 116 and the receiving portion of sockets 108 are a hexagonal shape.

Referring to FIG. 9, in a particular embodiment, handle 102 includes a shaft receiver 128. Shaft receiver 128 is an opening formed in outer side surface 113 of handle 102 configured to engage shaft 104. Shaft receiver 128 is located at a position between first end 112 and second end 114. As shown, shaft receiver 128 is centrally located along handle 102. Shaft 104 may be removably coupled to shaft receiver 128. When shaft 104 is coupled to shaft receiver 128, handle 102 can be used as a t-handle. A t-handle can be used for providing different torque and hand positioning for engaging fasters with sockets 108. When shaft 104 is received within shaft receiver 128, shaft 104 extends in a direction perpendicular to longitudinal axis 110. As shown, When shaft 104 is received within shaft receiver 128, shaft 104 is perpendicular to cavity axes 123 of cavities 105-107. In this way, both cavities 105-107 and the t-handle configuration may be used.

The shaft receiver 128 may be included on multiple types of tools, such as screwdrivers or other driving tools. Additionally, shaft receiver 128 may be on driving tools that do not include cavities 105-107. In the specific embodiment shown, shaft receiver 128 is a ¼ inch hex receiver with a hexagonal shaped opening.

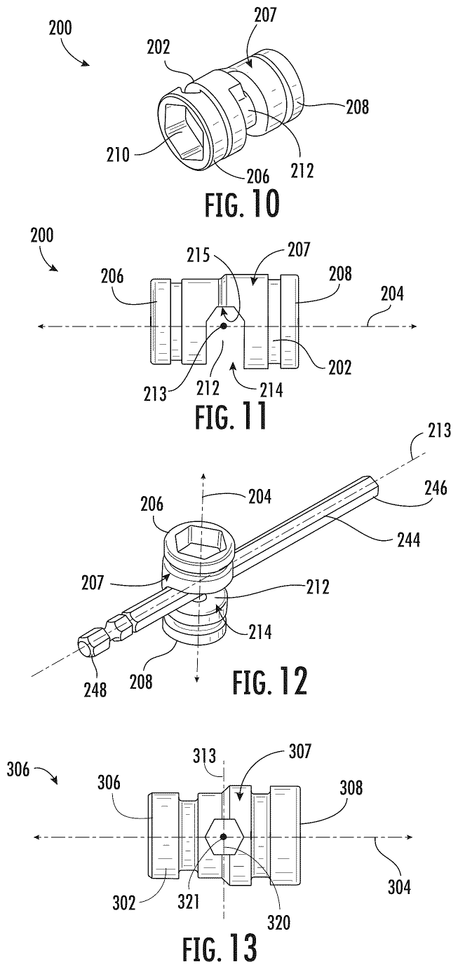

Referring generally to FIGS. 10-13, various embodiments of an engagement bit for a driving tool are shown. Specifically, referring to FIGS. 10-12, a reversible socket 200 is shown. Reversible socket 200 includes a body 202 that extends along a longitudinal axis 204. Body 202 has a first end 206 and a second end 208. Second end 208 is located opposite first end 206 along longitudinal axis 204. An outer side wall 207 extends along body 202 of socket between first end 206 and second end 208. First end 206 and second end 208 are configured to receive and retain a shaft, such as shaft 244. Shaft 244 is substantially the same as shaft 104.

Socket 200 further includes a first channel, or axial channel 210, and a second channel, or radial channel 212. Axial channel 210 is formed in socket 200 and extends along longitudinal axis 204 from first end 206 to second end 208. Axial channel 210 extends the length of body 202. A mounting end 246 of shaft 244 is configured to removably couple to socket 200 within axial channel 212.

Radial channel 212 is formed in socket 200 at a position located between first end 206 and second end 208 such that the radial channel intersects with axial channel 210. Radial channel 212 extends through at least a portion of the width of socket 200. Radial channel 212 extends along a channel axis 213. Channel axis 213 is oriented perpendicular to longitudinal axis 204. In this way, radial channel 212 is oriented perpendicular to axial channel 210.

Radial channel 212 is configured to engage shaft 244 to allow for sockets 200 to be engaged without removing shaft 104 from a handle, such as handle 102. Additionally, radial channel 212 allows for shaft 244 to act as a T-bar for driving fasteners.

As shown in FIG. 11, radial channel 212 is a slot, which defines an inner wall 215. Inner wall 215 helps define a polygonal shaped end of radial channel which is shaped to engage with the shape of shaft 244. In particular, radial channel 212 defines an opening 214 along outer side wall 207 of socket 200. Opening is configured to receive and retain a body 247 of shaft 244. In a specific embodiment, opening 214 extends a distance around outer side wall 207 of socket 200 greater than 50% of the perimeter of outer side wall 207. In another specific embodiment, socket 200 is a cylinder shape, and opening 214 extends a distance around socket 200 greater than 50% of a circumference of outer side wall 207.

As shown in FIG. 12, shaft 244 may act as a T-bar, or sliding t-handle, for driving fasteners. A T-bar allows shaft 244 to act as a handle and provide greater handle leverage when driving a fastener. When shaft 244 is received in radial channel 212, shaft 244 can be rotated around longitudinal axis 204 to drive a fastener into a workpiece.

To use shaft 244 as a T-bar, first, shaft 244 is engaged or mounted within radial channel 212 such that body 247 of shaft 244 is oriented in a direction transverse to longitudinal axis 204. More specifically, shaft 244 is inserted into radial channel 212 through opening 214 and pushed through radial channel 212 until it abuts an inner wall 215. When positioned within radial channel 212, shaft 244 is aligned in a direction parallel to channel axis 213. Then, shaft 244 is rotated around longitudinal axis 204. This rotates socket 200 and drives a fastener into a workpiece.

Referring to FIG. 13, reversible socket 300 is shown. Reversible socket 300 is substantially the same as reversible socket 200, except for the difference as discussed herein. Reversible socket includes a through bore 320.

Reversible socket 300 includes body 302 that extends along a longitudinal axis 304. Body 302 has a first end 306 and a second end 308. Second end 308 is located opposite first end 306 along longitudinal axis 304. Further, socket 300 includes an axial channel 310 (not shown), a radial channel 312 (not shown), and a through bore 320. Axial channel 310 extends along longitudinal axis 304 from first end 306 to second end 208. Radial channel 312 extends along a channel axis 313 which is oriented perpendicular to longitudinal axis 304. Through bore 320 extends along a bore axis 321. Bore axis 321 is perpendicular to longitudinal axis 304 and perpendicular to channel axis 313.

Through bore 320 extends through a width of socket 300 and intersects radial channel 312. In particular, through bore 320 extends through an outer side surface 307 of body 302 and through an inner wall 315 defined by radial channel 312.

Through bore 320 is configured to engage a shaft 104 to allow for sockets 300 to be engaged without removing shaft 244 from a handle, such as handle 102. Additionally, through bore 320 allows for shaft 244 to act as a T-bar for driving fasteners. As shown, through bore 320 is a hexagonal-shaped hole.

It should be understood that the figures illustrate the exemplary embodiments in detail, and it should be understood that the present application is not limited to the details or methodology set forth in the description or illustrated in the figures. It should also be understood that the terminology is for description purposes only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes, and omissions may also be made in the design, operating conditions, and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element and is not intended to be construed as meaning only one.

Various embodiments of the disclosure relate to any combination of any of the features, and any such combination of features may be claimed in this or future applications. Any of the features, elements, or components of any of the exemplary embodiments discussed above may be utilized alone or in combination with any of the features, elements, or components of any of the other embodiments discussed above.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in any claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths, and radii, as shown in the Figures are to scale. Actual measurements of the Figures will disclose relative dimensions, angles, and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A driving tool, comprising:
a longitudinal axis;
a handle having a first end and a second end opposite the first end along the longitudinal axis;
a shaft coupled to the first end of the handle;
a cavity centered on and extending along a cavity axis, the cavity formed in the handle at a position located between the first end and the second end;
an engagement bit removably secured within the cavity; and
wherein the cavity axis is orientated at an angle with respect to the longitudinal axis such that the cavity axis intersects the longitudinal axis.

2. The driving tool of claim 1, wherein the cavity axis is perpendicular to the longitudinal axis.

3. The driving tool of claim 1, wherein an outer wall of the engagement bit interfaces with an interior wall of the cavity, when the engagement bit is secured within the cavity.

4. The driving tool of claim 1, wherein the engagement bit forms an interference fit with the cavity.

5. The driving tool of claim 1, wherein the cavity comprises a first opening and a second opening opposite the first opening along the cavity axis, wherein the handle further comprises an outer side surface extending between the first end and the second end, wherein the first opening and the second opening are defined along the outer side surface of the handle, and wherein the cavity is configured such that the engagement bit can be removed from the cavity from the first opening.

6. The driving tool of claim 5, wherein the cavity further comprises a step positioned adjacent to the second opening and extending from an interior wall of the cavity in a direction towards the cavity axis.

7. The driving tool of claim 5, wherein the cavity is configured such that the engagement bit can be removed from the cavity from the second opening.

8. The driving tool of claim 1, further comprising a channel formed in the handle and spaced a distance from the longitudinal axis, the channel configured to receive and retain the shaft, wherein the channel extends through the handle in a direction parallel to the longitudinal axis.

9. The driving tool of claim 8, wherein the channel is centered on and extends along a channel axis, wherein the channel axis is skew to the cavity axis.

10. A driving tool, comprising:
a handle extending along a longitudinal axis, the handle having a first end and a second end opposite the first end along the longitudinal axis;
a shaft removably coupled to the first end of the handle;
a first bit;
a second bit, the first bit and the second bit configured to engage a mounting end of the shaft;
a first cavity configured to receive and retain the first bit;
a second cavity configured to receive and retain the second bit; and
a solid area formed within the handle extending without openings in a direction along the longitudinal axis between the first cavity and the second cavity.

11. The driving tool of claim 10, wherein the second cavity has a greater width than the first cavity.

12. The driving tool of claim 10, wherein the first bit is secured within the first cavity through an interference fit.

13. The driving tool of claim 10, further comprising a third bit and a third cavity configured to receive the third bit.

14. The driving tool of claim 10, further comprising an opening formed in the handle between the first end and the second end, the opening configured to removably couple to the shaft, wherein when the shaft is secured within the opening the shaft is oriented perpendicular to the longitudinal axis.

15. The driving tool of claim 14, wherein the first cavity extends along a cavity axis, and wherein, when the shaft is secured within the opening, the shaft is oriented perpendicular to the cavity axis.

16. A driving tool, comprising:
a socket centered on and extending along a longitudinal axis, the socket comprising:
a first end;
a second end opposite the first end along the longitudinal axis;
an outer side wall extending along the socket between the first end and the second end;
a first channel formed in the socket extending along the longitudinal axis from the first end to the second end; and
a second channel formed in the socket at a position located between the first end and the second end such that the second channel intersects the first channel, the second channel defining an opening along the outer side wall;
a shaft, comprising:
a mounting end configured to removably couple to the socket within the first channel; and
a body configured to be received and retained within the second channel; and
wherein, when the shaft is received in the second channel, the shaft can be rotated around the longitudinal axis to drive a fastener into a workpiece.

17. The driving tool of claim 16, wherein the second channel is oriented perpendicular to the first channel.

18. The driving tool of claim 16, wherein the socket includes a bore that extends through a width of the socket and intersects the second channel.

19. The driving tool of claim 16, wherein the socket is a cylinder shape, and wherein the opening extends a distance around the outer side wall greater than 50% of a circumference of the outer side wall.

20. The driving tool of claim 16, wherein the second channel defines an inner wall, and wherein a side of the body of the shaft interfaces with the inner wall when the shaft is received in the second channel.
